(19) United States
(12) Patent Application Publication
(10) Pub. No.: US 2025/0277538 A1
(43) Pub. Date: Sep. 4, 2025

(54) Acid Ball Valve Assembly for Railroad Tank Car

(71) Applicant: McKenzie Valve and Machining LLC, McKenzie, TN (US)

(72) Inventors: Cole Clint RANKIN, Greenwell Springs, LA (US); Roger Dale DANZY, Chatham, LA (US); Florinel Dumitru BODNARIUC, Burlington, Ontario (CA)

(73) Assignee: McKenzie Valve and Machining LLC, McKenzie, TN (US)

(21) Appl. No.: 19/063,239

(22) Filed: Feb. 25, 2025

Related U.S. Application Data
(60) Provisional application No. 63/559,517, filed on Feb. 29, 2024.

(51) Int. Cl. F16K 27/06; B61D 5/00; F16K 5/06

(52) U.S. Cl. CPC F16K 27/067; B61D 5/008; F16K 5/0631

(57) ABSTRACT

A ball valve assembly for a railroad tank car is disclosed herein. The ball valve assembly may comprise a ball valve removably coupled to an end of a fittings flange of a railroad tank car, a dual thread retainer assembly affixed to an end of the ball valve opposite the fittings flange, and an anti-rotation assembly attached to the fittings flange. The dual thread retainer assembly may comprise a retainer affixed to the end of the ball valve opposite the fittings flange and a cap removably affixed to an end of the retainer opposite the ball valve. The anti-rotation assembly may comprise a base affixed to the fittings flange and a fork secured to the base that is configured to prevent rotation of the ball valve and the dual thread retainer assembly with respect to the fittings flange.

### RELATED APPLICATIONS

This application claims priority to U.S. Provisional Patent Application No. 63/559,517filed Feb. 29, 2024, the content of which is hereby incorporated herein by reference in its entirety.

### FIELD OF THE INVENTION

The present invention relates to railroad tank cars and, more particularly, to acid ball valves used on railroad tank cars.

### BACKGROUND OF THE INVENTION

Railroad tank cars are frequently used to transport a variety of liquid or gaseous commodities, such as acid, fertilizer, polymer, crude oil, food grain products, and/or other goods or resources. Acid ball valves are frequently used on railroad tank cars because they can handle acid or corrosive fluids, and/or other resources. However, the threaded portion of acid ball valves often suffer wear and tear during installation and/or maintenance operations due, for example, to over-torquing when installing or tightening the valve to a tank car or installing a plug into the valve. This wear and tear and/or over-torquing can cause stripping to the threaded portion or stretch the threaded portion beyond its limits. This can result in loose plugs, valves, or loading equipment which may cause leaks from the tank car when there is positive pressure in the tank car. Such leaks must be detected and repaired before the tank car continues its route. In addition, due to vibration of the valve during transportation, there may be a risk of potential rotation or twisting of an installed ball valve and/or additional components coupled to a component of a ball valve assembly. To ensure acid ball valves are in proper working order, the valves also need to be inspected to ensure there are not any leaks. Any acid ball valve assembly that can reduce the aforementioned risks would represent an improvement over conventional acid ball valves used on railroad tank cars.

### SUMMARY OF THE INVENTION

Aspects of this disclosure relate to a ball valve assembly for a railroad tank car. In various embodiments, the ball valve assembly comprises a ball valve removably coupled to an end of a fittings flange of a railroad tank car, a dual thread retainer assembly affixed to an end of the ball valve opposite the fittings flange, and an anti-rotation assembly securely attached to the fittings flange to prevent rotation of the ball valve and the dual thread retainer assembly with respect to the fittings flange. In various embodiments, the dual thread retainer assembly comprises a retainer affixed to the end of the ball valve opposite the fittings flange and a cap removably affixed to an end of the retainer opposite the ball valve. In various embodiments, the cap is removably affixed to the retainer via an inner threaded portion of the cap and a first outer threaded portion of the retainer. In some embodiments, the first outer threaded portion includes one or more channels to allow leaks to be detected prior to removing the cap from the retainer.

In various embodiments, the retainer further comprises a second outer threaded portion via which the retainer is affixed to the end of the ball valve opposite the fittings flange. In some embodiments, the dual thread retainer assembly further comprises an O-ring at the interface between the cap and the retainer that is configured to allow the cap to be sufficiently tightened (e.g., to form a seal) when the cap is affixed to the retainer. In some embodiments, the O-ring is configured to be retained within the cap when the cap is removed from the retainer. In some embodiments, the end of the retainer opposite the ball valve includes a tapered outer edge. In such embodiments, the tapered outer edge may be radiused for fitment of the O-ring. For example, the tapered outer edge may be sized such that it is configured to stretch the O-ring to a particular size and align the O-ring with respect to the retainer when the cap is affixed to the retainer.

According to another aspect of this disclosure, an anti-rotation assembly for use with a ball valve assembly affixed to a railroad tank car is described herein. The anti-rotation assembly may include a base affixed to the fittings flange and a fork secured to the base that is configured to prevent rotation of the ball valve with respect to the fittings flange. In various embodiments, the base is welded to an exposed surface of the fittings flange. In various embodiments, an opening in the fork and an opening in the base, when aligned, are each configured to receive a single fastener configured to secure the fork to the base. In some embodiments, the opening in the fork may comprise a slot configured to allow a position of the fork to be adjusted relative to the base. In various embodiments, the fork includes a portion that partially surrounds the ball valve and is configured to prevent rotation of the ball valve with respect to the fittings flange. In some embodiments, such a portion of the fork comprises a hexagonal grabbing profile configured to provide increased surface contact area with the ball valve.

According to another aspect of the invention, a method for installing a ball valve assembly at a fittings flange of a railroad tank car is disclosed herein. In various embodiments, the method comprises removably coupling a threaded nipple to an end of a fittings flange of a railroad tank car. In various embodiments, the method further comprises coupling a ball valve to the fittings flange via the threaded nipple. In various embodiments, the method further comprises securely attaching a base of an anti-rotation assembly to the fittings flange. In various embodiments, the method further comprises fastening a fork of the anti-rotation assembly to the base, wherein the fork is configured to prevent rotation of the ball valve with respect to the fittings flange. In some embodiments, securely attaching the base of the anti-rotation assembly to the fittings flange includes marking a position that provides a gap between the fork and a termination point of an interfacing region of the ball valve. In some embodiments, the method further comprises affixing a dual thread retainer assembly to an end of the ball valve opposite the fittings flange, the dual thread retainer assembly comprising a retainer affixed to the end of the ball valve opposite the fittings flange and a cap removably affixed to an end of the retainer opposite the ball valve. In some embodiments, the method further comprises removably affixing a cap to the retainer via an inner threaded portion of the cap and a first outer threaded portion of the retainer, wherein the retainer further comprises a second outer threaded portion, and wherein the retainer is affixed to the end of the ball valve opposite the fittings flange via the second outer threaded portion. In some embodiments, the first outer threaded portion includes one or more channels to allow leaks to be detected prior to removing the cap from the retainer.

These and other objects, features, and characteristics of the invention disclosed herein will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

The present invention is illustrated by way of example and not limited in the accompanying figures in which like reference numerals indicate similar elements and in which:

FIG. 1 depicts a perspective view of an example acid ball valve assembly for a railroad tank car, according to one or more aspects described herein;

FIGS. 2A-B depict cross-sectional views of an example ball valve assembly, according to one or more aspects described herein;

FIGS. 3A-B depict perspective views of an example ball valve assembly with a valve handle in an open and closed position, according to one or more aspects described herein;

FIGS. 4A-D depict various views of an example dual thread retainer assembly for a ball valve assembly, according to one or more aspects described herein;

FIGS. 5A-C depict various additional views of an example dual thread retainer assembly for a ball valve assembly, according to one or more aspects described herein;

FIGS. 6A-E depict various views of an example ball valve assembly with an anti-rotation assembly, according to one or more aspects described herein;

FIGS. 7A-B depict various views of an example ball valve assembly with an anti-rotation assembly, according to one or more aspects described herein;

FIGS. 8A-C depict various views of an example ball valve assembly with a safety chain, according to one or more aspects described herein;

FIGS. 9A-B depict perspective views of alternative embodiments of one or more components of a ball valve assembly, according to one or more aspects described herein;

FIGS. 10A-E provide a pictorial representation of an example process for installing a ball valve assembly to a fittings flange, according to one or more aspects described herein;

FIG. 11 depicts a flow diagram of an example method for installing an example ball valve assembly mounted to a railroad tank car, according to one or more aspects described herein.

These drawings are provided for purposes of illustration only and merely depict typical or example embodiments. These drawings are provided to facilitate the reader's understanding and shall not be considered limiting of the breadth, scope, or applicability of the disclosure. For clarity and ease of illustration, these drawings are not necessarily drawn to scale.

### DETAILED DESCRIPTION

In the following description of various examples of the invention, reference is made to the accompanying drawings, which form a part hereof, and in which are shown by way of illustration various example structures, systems, and steps in which aspects of the invention may be practiced. These aspects are indicative, however, of but a few of the various ways in which the principles of the invention may be employed and the present invention is intended to include all such aspects and their equivalents. It is to be understood that other specific arrangements of parts, structures, example devices, systems, and steps may be utilized, and structural and functional modifications may be made without departing from the scope of the present invention. Also, while the terms “top,” “bottom,” “front,” “back,” “side,” and the like may be used in this specification to describe various example features and elements of the invention, these terms are used herein as a matter of convenience, e.g., based on the example orientations shown in the figures. Nothing in this specification should be construed as requiring a specific three-dimensional orientation of structures in order to fall within the scope of this invention.

The invention described herein relates to a ball valve assembly for a railroad tank car configured to reduce the risk of potential leaks due to the wear and tear that may occur on a threaded portion of a ball valve. Another aspect of the invention described herein relates to a ball valve assembly for a railroad tank car that reduces risk of potential rotation or twist of the ball valve and/or one or more flow control components that may surround an outer portion of the ball valve.

For convenience, the ball valve assembly and methods of installing a ball valve described herein may comprise or be suitable for use with an acid ball valve affixed (or configured to be affixed) to a railroad tank car. However, it is to be understood that the ball valve assembly and methods of installing the same described herein may be equally applicable in other applications without departing from the scope of the invention. For example, the ball valve described herein may also be utilized in other applications, such as in other applications involving tanks or other storage containers to which a ball valve may be installed.

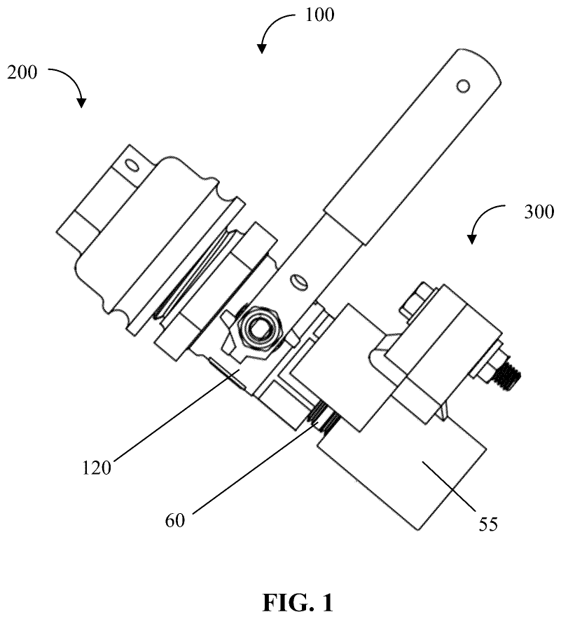

FIG. 1 depicts a perspective view of an acid ball valve assembly 100 for a railroad tank car, according to one or more aspects described herein. In various embodiments, ball valve assembly 100 may include a ball valve 120, dual thread retainer assembly 200 affixed to an end of ball valve 120, an anti-rotation assembly 300, and/or one or more other components. In various embodiments, ball valve 120 may be removably coupled to an end of a fittings flange 55 via a threaded nipple 60. The anti-rotation assembly 300 may be securely attached to the fittings flange 55 to prevent rotation of the ball valve 120 and dual thread retainer assembly 200 with respect to the fittings flange 55 and/or one or more other components. In various embodiments, ball valve assembly 100 may be configured to reduce the risk of potential leaks due to wear and tear that may occur on threaded portions of the ball valve.

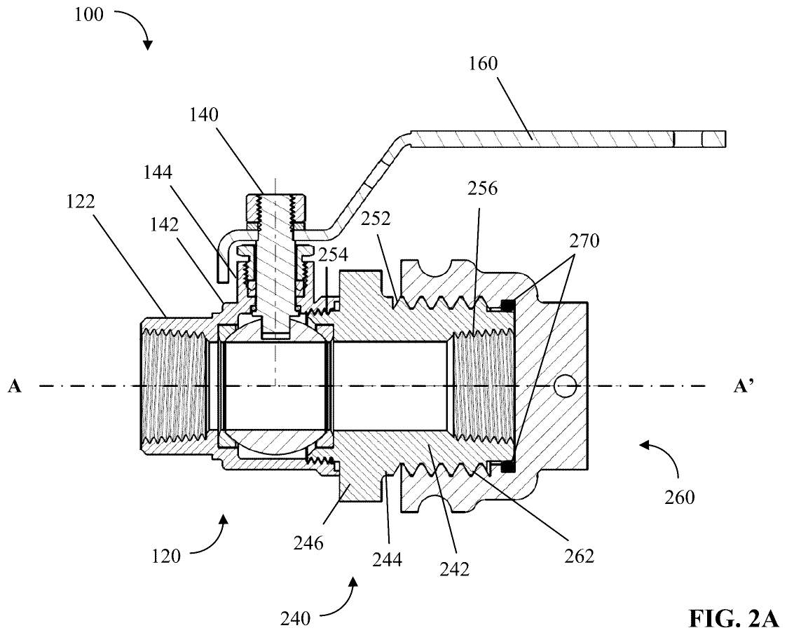

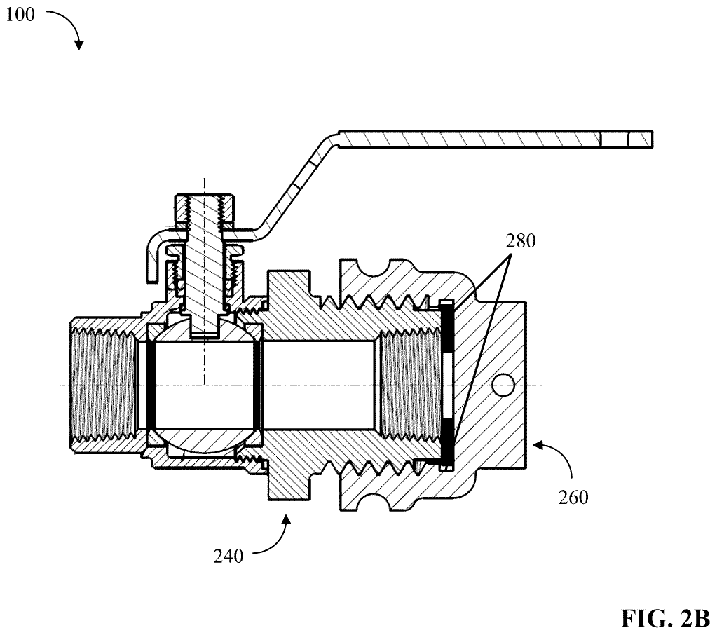

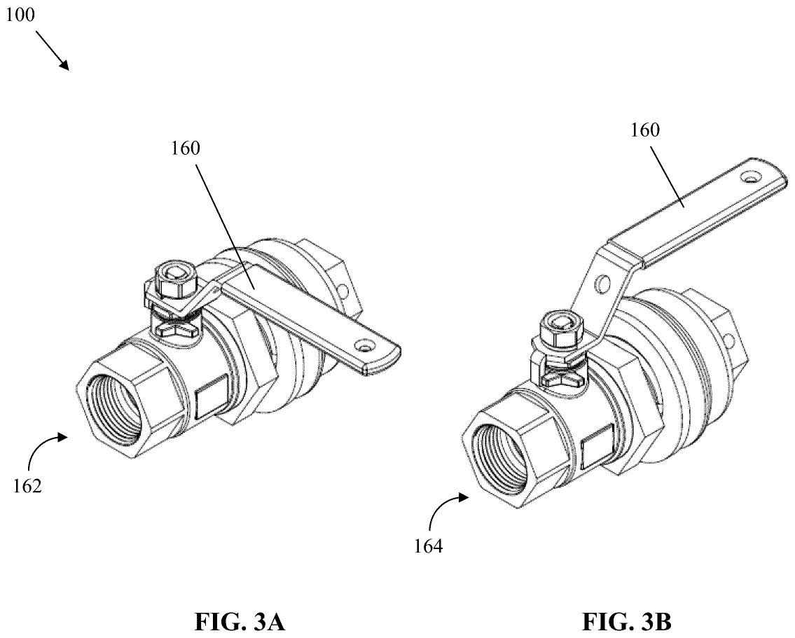

FIGS. 2A-B depict cross-sectional views of ball valve assembly 100, according to one or more aspects described herein. In various embodiments, ball valve assembly 100 may include a ball valve 120, dual thread retainer assembly 200 affixed to an end of the ball valve 120, an anti-rotation assembly 300 (not shown in FIGS. 2A-B), and/or one or more other components. In various embodiments, ball valve 120 may include a valve body 122, valve stem 140, a valve handle 160, and/or one or more other components. In some embodiments, valve handle 160 may be rotatably movable with respect to the valve stem 140 between an open position and a closed position. In various embodiments, valve body 122 of ball valve assembly 100 may define an interior cavity of the ball valve 120 that is revealed by rotating a valve handle 160 from a closed position 162 to an open position 164, for example, as depicted in FIGS. 3A-B.

Indeed, FIGS. 3A-B depict various views of ball valve 120 with a valve handle 160, according to one or more aspects described herein. In various embodiments, valve handle 160 of ball valve assembly 100 may be slidably rotated from a closed position 162 to an open position 164 to control flow path of ball valve assembly 100. For example, in some implementations, ball valve 120 may be a quarter turn valve, in which the valve handle 160 turns only 90 degrees from a fully closed position 162 to a fully open position 164 of the valve.

Returning to FIGS. 2A-B, in various embodiments, valve stem 140 may be mated to and received within an opening of valve body 122. In various embodiments, valve stem 140 may comprise a stem base 142 and a stem body 144 that extends outwardly to receive and engage with valve handle 160 of ball valve assembly 100. For example, as depicted in FIG. 2A, stem body 144 may be configured to extend away from stem base 142 along an axis perpendicular to a longitudinal axis A-A′ along which ball valve assembly 100 is mounted. In various embodiments, valve stem 140 may be configured to receive nuts, washers, and/or other types of fasteners used to secure valve handle 160 to ball valve assembly 100. For example, valve stem 140 may be configured to receive nuts, washers, and/or other types of fasteners used to removably attach valve handle 160 to the valve stem 140 of ball valve 120.

In various embodiments, the valve body 122 may include a first valve threaded portion and a second valve threaded portion along a longitudinal axis A-A′. In some embodiments, ball valve assembly 100 may be coupled to an end of a fittings flange 55 via a threaded nipple 60 (as depicted in FIG. 1) at the first valve threaded portion using one or more techniques described herein and/or using any other now known or future developed fastening technique. For example, a tapered threaded configuration may be utilized at the fittings flange 55 on a top or side of a railroad tank car to be coupled with the valve body 122 of ball valve assembly 100. While a tapered threaded portion is described herein, it should be understood that any appropriate modification of the first and second threaded portion may be contemplated and is within the scope of the invention described herein.

In various embodiments, ball valve assembly 100 described herein may include a dual thread retainer assembly 200 comprising a retainer 240 and a removable cap 260. In various embodiments, retainer 240 may be affixed to an end of the ball valve 120. For example, retainer 240 may be welded (or securely attached) to valve body 122 once it is threaded in such that it forms a functional part of valve body 122 (and ball valve assembly 100). In various embodiments, retainer 240 of ball valve assembly 100 may be substantially cylindrical with a retainer base at the base to mate with the ball valve 120. As described herein, in various embodiments, retainer 240 may comprise a retainer body 242 having at least side walls 244, a retainer base 246, and/or one or more other components. In various embodiments, retainer 240 may be mated to and received within an opening of valve body 122. As depicted in FIG. 2A, in various embodiments, retainer 240 may comprise the retainer base 246 and the retainer body 242 that extends axially towards cap 260. For example, retainer body 242 may be configured to extend away from retainer base 246 along a longitudinal axis perpendicular to a mounting surface to which ball valve assembly 100 is mounted.

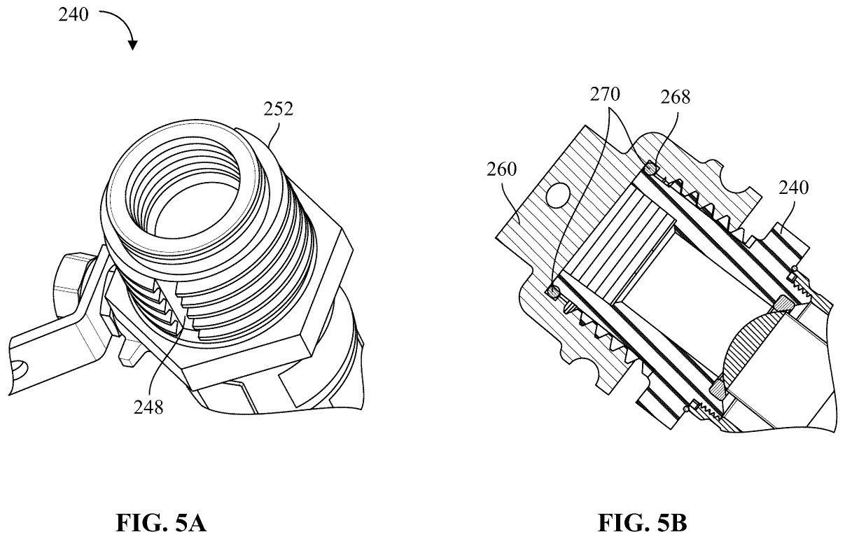

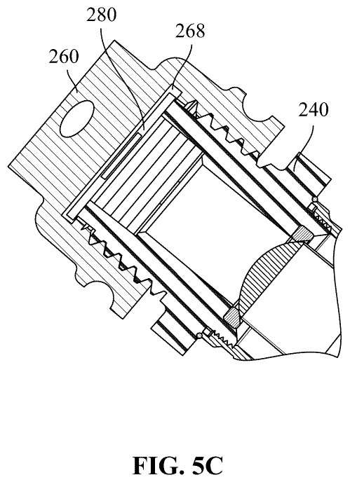

In some embodiments, as depicted in FIG. 2A, cap 260 may include an O-ring 270 configured to seal interface between cap 260 and retainer 240. In some embodiments, O-ring 270 may be constructed of an elastomer material that can deform to fill surface imperfections in the groove 268 of cap 260 and the interior of retainer 240 (as depicted in FIG. 5B), thereby enabling tighter sealing of ball valve assembly 100. The O-ring 270 may allow metal to metal contact of cap 260 and retainer 240, which enables cap 260 to be torqued sufficiently tight (regardless of cap torque value) without over-compressing O-ring 270. In some embodiments, O-ring 270 (and cap 260) may be configured such that O-ring 270 is retained within cap 260 when cap 260 is removed from retainer 240. In alternative embodiments, and as depicted in FIG. 2B and/or FIG. 5C, cap 260 may include a gasket ring 280 configured to seal interface between cap 260 and retainer 240.

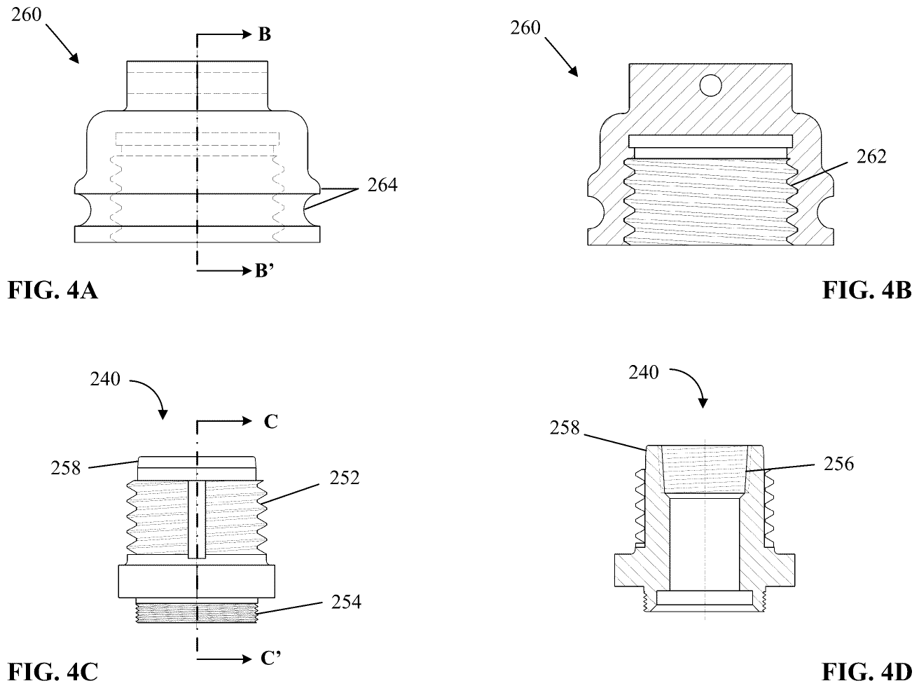

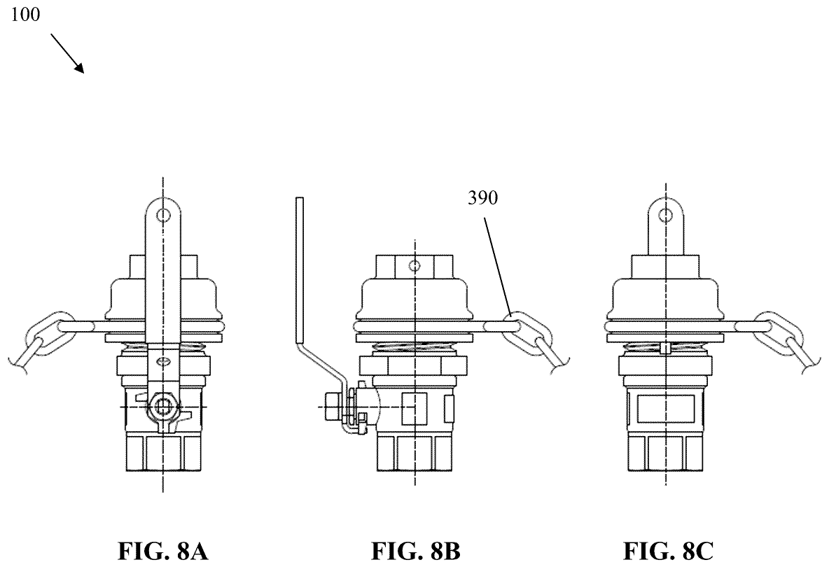

In various embodiments, retainer body 242 of retainer 240 may include a first outer threaded portion 252, a second outer threaded portion 254, and an inner threaded portion 256. In various embodiments, a cap 260 may be removably engaged to a top side of retainer 240. The cap 260 may include an inner threaded portion 262 corresponding to a first outer threaded portion 252. In various embodiments, dual thread retainer assembly 200 may include a removable cap 260 coupled to an end of a retainer 240, which itself is affixed to an end of the ball valve 120. FIGS. 4A-D depict various views of an example dual thread retainer assembly 200 for ball valve assembly 100, according to one or more aspects described herein. For example, FIG. 4A depicts a perspective view of cap 260 of ball valve assembly 100, FIG. 4B depicts a cross-sectional view of the cap 260 as depicted in FIG. 4A along a line B-B′, FIG. 4C depicts a perspective view of retainer 240 of ball valve assembly 100, and FIG. 4D depicts a cross-sectional view of the retainer 240 as depicted in FIG. 4C along a line C-C′. In various embodiments, cap 260 may include one or more portions with a vertically varying profile 264. For example, the vertically varying profile may be present in outer portion of cap 260 extending along the line B-B′ to provide ease of use and further engagement between cap 260 and retainer 240 with minimum torque. In some embodiments, the vertically varying profile 264 of cap 260 may include (or form) one or more grooves. In some embodiments, grooves in (or on) cap 260 may used, for example, to retain a safety chain, such as safety chain 390 depicted in and described herein with respect to FIGS. 8A-C.

In some embodiments, as depicted, for example, in FIGS. 4C-D, retainer 240 may include a tapered outer edge 258 to receive an O-ring (such as O-ring 270 depicted in FIG. 2A and described herein). In other words, retainer 240 may include a chamfer (or tapered edge) at a top portion of the retainer 240 configured to enable an easy entry and/or exit of an O-ring to reduce risk of any potential damage during compression. In some embodiments, tapered outer edge 258 may be configured to provide room for an O-ring to slide into position while ensuring the O-ring is not damaged during compression. For example, tapered outer edge 258 may be radiused for fitment of an O-ring. In various embodiments, tapered outer edge 258 may be sized such that it is configured to stretch the O-ring to a particular size and align the O-ring with respect to retainer 240 when cap 260 is affixed to retainer 240. For example, tapered outer edge 258 may be configured to help O-ring 270 slide into position when cap 260 is screwed on. In such embodiments, the taper on tapered outer edge 258 may be configured to allow for optimized compression on O-ring 270 and its tapered and radius shape ensures O-ring 270 can stretch into position without being pinched or cut.

In various embodiments, cap 260 may be removably engaged to a top side of retainer 240. As depicted in FIGS. 4B-C, cap 260 may include an inner threaded portion 262 corresponding to a first outer threaded portion 252 of retainer 240. For example, FIG. 2A depicts an embodiment of ball valve assembly 100 in which cap 260 is removably engaged to retainer 240 by dual threaded portions (or similar mechanism) including first outer threaded portion 252 and inner threaded portion 262 to reduce potential wear and tear that may occur on threaded portions of the ball valve such as internal threaded portion 256. In some embodiments, cap 260 may be made with any appropriate type of inner threaded portion 262 with a diameter, height, and/or shape of threaded portion selected to match diameter, height, and/or shape of corresponding first outer threaded portion 252 of retainer 240. As depicted in FIGS. 5A-B, cap 260 may be rotatably inserted over the corresponding (i.e., first outer threaded portion 252) portion of retainer 240.

FIGS. 5A-B depict various additional views of dual thread retainer assembly 200 for ball valve assembly 100, according to one or more aspects described herein. As described herein, ball valve assembly 100 may be configured to allow for improved control of the ball valve during installation on a railroad tank car. In various embodiments, ball valve assembly 100 may be configured to allow leaks to be detected without requiring cap 260 to be removed from the fittings flange 55 or requiring disassembling any components on the valve or the railroad tank car itself. For example in some embodiments, one or more channels 248 may be integrated in first outer threaded portion 252 of retainer 240 (as depicted in FIG. 5A) to allow leaks to be detected prior to removing the cap 260 from the retainer 240.

In various embodiments, the one or more channels 248 may extend axially (i.e., parallel to a longitudinal axis of ball valve assembly 100 along a straight path). For example, the one or more channels 248 may extend along a line C-C′, as depicted in FIG. 4C. In other embodiments, the one or more channels 248 may extend axially along a curved path. In some embodiments, the one or more channels 248 may comprise a rectangular opening along the straight path. In other embodiments, the one or more channels 248 may comprise a circular opening (e.g., when viewed from a vertical cross-sectional view) along the straight path. While one or more channels is described herein, it should be understood that any appropriate modification of the one or more channels 248 may be contemplated and is within the scope of the invention described herein. In various embodiments, and as depicted in FIG. 5A, a width of one end of one or more channels 248 may be the same width of the other end of one or more channels 248 along a line B-B′. In other embodiments, a width of one end of one or more channels 248 may include a different width of the other end of one or more channels 248 along a line C-C′. In some embodiments, the one or more channels 248 may include a channel profile to enhance the detection of the leak. In various embodiments, the one or more channels 248 may include any suitable number of channels. For example, as depicted in FIG. 5A, retainer 240 may include a single channel. However, retainer 240 may include two or more channels. In such embodiments, the one or more channels 248 may be equally spaced apart circumferentially around the first outer threaded portion 252 of retainer 240. In other embodiments, the one or more channels 248 may be generally spaced apart circumferentially around the first outer threaded portion 252 of retainer 240.

In various embodiments, cap 260 may include a groove 268, notch, or other type of depression configured to receive an O-ring 270 configured to seal off ball valve 120 at the dual thread retainer assembly 200 (i.e., between cap 260 and retainer 240) when ball valve 120 is in a closed position (as depicted, for example, in FIG. 5B). For example, cap 260 and retainer 240 may, together, form a groove 268 that makes compression effectively identical every time cap 260 is installed regardless of cap installation torque. In various embodiments, O-ring 270 may form a seal when ball valve 120 is in a closed position. In some embodiments, O-ring 270 may be constructed of an elastomer material that can deform to fill surface imperfections in the groove 268 of cap 260 and the interior of retainer 240, thereby enabling tighter sealing of ball valve assembly 100. In alternative embodiments, as depicted in FIG. 5C, cap 260 may include a gasket ring 280. For example, gasket ring 280 may comprise a quad ring or O-ring configured to form a seal when ball valve 120 is in a closed position. In some embodiments, gasket ring 280 may be constructed of an elastomer material that can deform to fill surface imperfections in the groove 268 of cap 260 and the interior of retainer 240, thereby enabling tighter sealing of ball valve assembly 100.

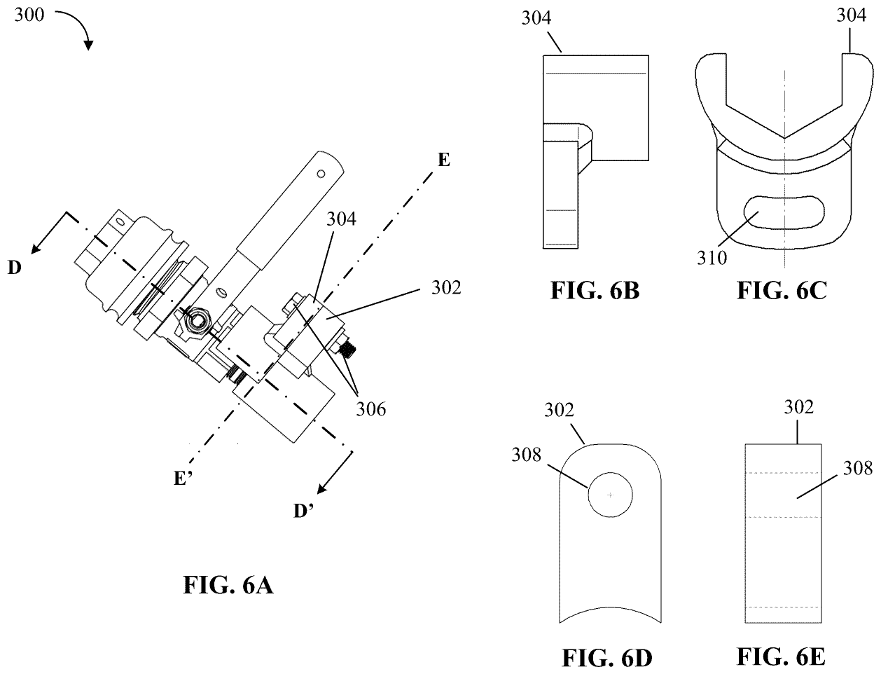

According to another aspect of the invention, ball valve assembly 100 described herein may include an anti-rotation assembly 300. FIGS. 6A-E depict various views of ball valve assembly 100 with an anti-rotation assembly 300, according to one or more aspects described herein. In various embodiments, the anti-rotation assembly 300 may include an anti-rotation base (or stop rod) 302, an anti-rotation fork 304, one or more anti-rotation fasteners 306 passing through one or more anti-rotation openings 308 and 310 of the anti-rotation base 302 and the anti-rotation fork 304, respectively. FIGS. 6B-C depict cross-sectional views of anti-rotation fork 304 as depicted in FIG. 6A along a line E-E′, and FIGS. 6D-E depict cross-sectional views of anti-rotation base 302 as depicted in FIG. 6A. In various embodiments, anti-rotation assembly 300 may be securely attached to fittings flange using one or more coupling elements and one or more techniques described herein and/or using any other now known or future developed fastening technique. For example, in some embodiments, anti-rotation assembly 300 (as depicted, for example, in FIGS. 6A-E) may be welded to an exposed surface of fittings flange 55 (or the tank car) and removably attached to the ball valve assembly 100 via anti-rotation fork 304 and/or one or more anti-rotation fasteners 306. In other embodiments, anti-rotation assembly 300 may be positioned surrounding the fittings flange 55 and attached to anywhere outside of fittings flange 55 by any appropriate fastening configuration.

In various embodiments, ball valve 120 and/or dual thread retainer assembly 200 would function the same way with or without the anti-rotation assembly 300. However, anti-rotation assembly 300 may greatly reduce the risk of potential rotation or twist of ball valve 120 and/or dual thread retainer assembly 200 relative to fittings flange 55 and one or more flow control components that may surround outer portion of the ball valve assembly 100.

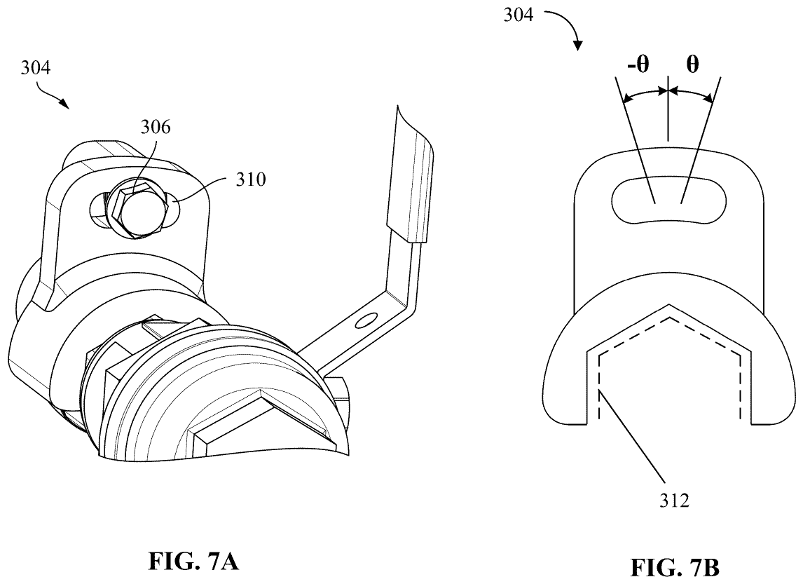

FIGS. 7A-B depict various views of ball valve assembly 100 with anti-rotation assembly 300, according to one or more aspects described herein. In various embodiments, anti-rotation assembly 300 may include an anti-rotation fork 304 with a slot 310 to allow the position of one or more anti-rotation fasteners 306 to be adjusted and to further provide benefits of rotational freedom when installing or tightening the ball valve for installation or transportation. For example, in some embodiments, one or more anti-rotation fasteners 306 (e.g., bolts) may be used to attach the anti-rotation fork 304 to anti-rotation base 302 via a slot 310, and may be adjusted in a range of an angle 0 from about 5 degrees (i.e., −5° to 5°)to about 15 degrees (i.e., −15° to 15°) relative to the valve body 122. In a particular embodiment, the range of an angle 0 may be about 10 degrees (i.e., −10° to 10°). In various embodiments, and as depicted in FIG. 7B, anti-rotation fork 304 may be made with any appropriate shape of grabbing profile 312 with a size and/or shape of grabbing profile selected to match size and/or shape of corresponding (i.e., grabbing) portion of ball valve 120. For example, a half hexagonal grabbing profile may provide increased surface contact area with ball valve 120 than a traditional square fork. In various embodiments, the size and/or shape of the grabbing profile 312 of anti-rotation fork 304 may correspond to an outer edge of ball valve 120 and/or another component of ball valve assembly 100 such that a portion of anti-rotation fork 304 partially surrounds and prevents rotation of ball valve 120 (or another component of ball valve assembly 100) with respect to the fittings flange 55.

FIGS. 8A-C depict various views of ball valve assembly 100 with a safety chain 390, according to one or more aspects described herein. As described herein, in various embodiments, dual thread retainer assembly 200 of ball valve assembly 100 may include a removable cap 260. In such embodiments, ball valve assembly 100 may include (or interface with) a safety chain 390 configured to be attached to removable cap 260 and any of the one or more other components of ball valve assembly 100 described herein or the tank car itself, such that safety chain 390 may secure removable cap 260 when removable cap 260 is unscrewed or otherwise detached from retainer 240. In other words, safety chain 390 may serve as a tether to ensure removable cap 260 is not lost when removable cap 260 is removed from retainer 240.

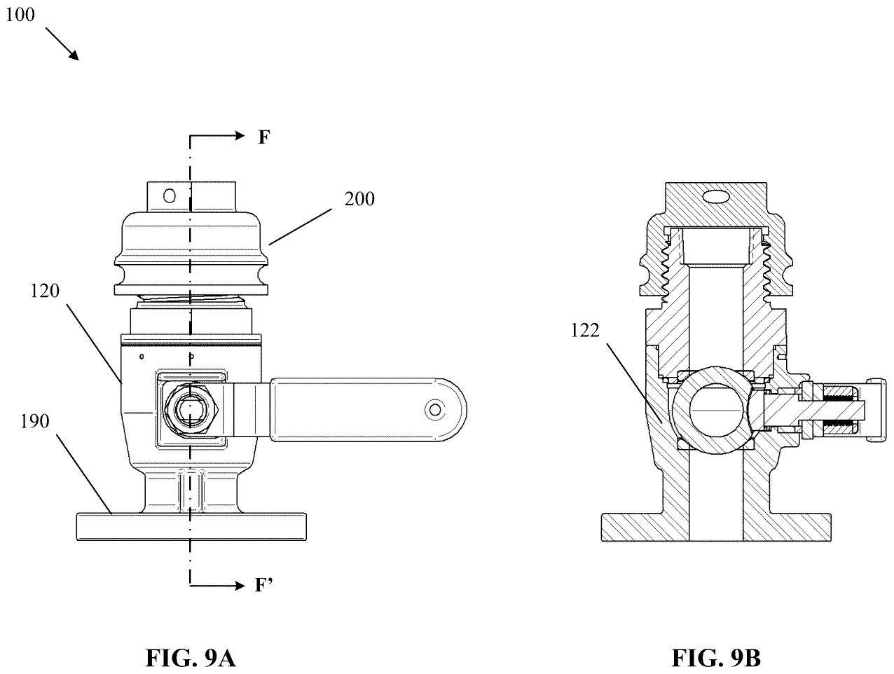

FIGS. 9A-B depict perspective views of alternative embodiments of one or more components of ball valve assembly 100, according to one or more aspects described herein. FIG. 9B depicts a cross-sectional view of the ball valve 120 as depicted in FIG. 9A along a line F-F′. In various embodiments, ball valve assembly 100 may include a ball valve 120 with a flanged connection 190 and a dual thread retainer assembly 200, and/or one or more other components. For example, as depicted in FIGS. 9A-B, the ball valve 120 may comprise a valve body 122 that comprises a flanged portion 190 at an end couple to fittings flange. In such embodiments, anti-rotation assembly 300 may not be needed because the flanged connection 190 may eliminate the risk of potential rotation or twist of ball valve 120 and/or dual thread retainer assembly 200 relative to fittings flange.

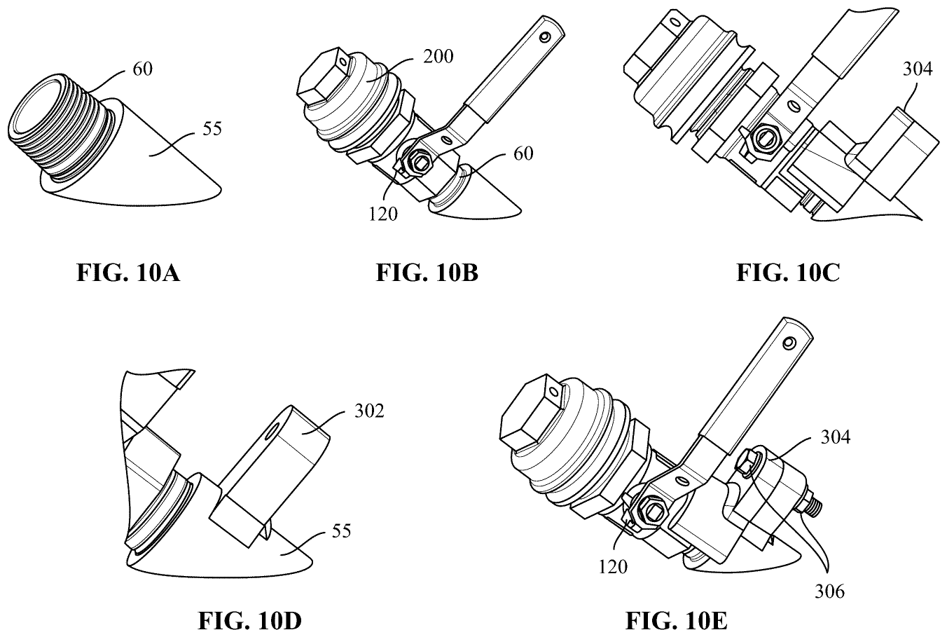

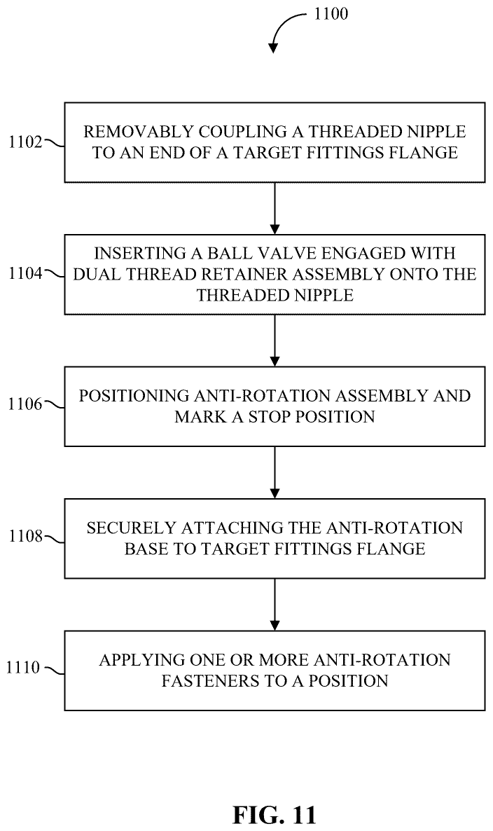

FIGS. 10A-E provide a pictorial representation of an example process for installing a ball valve assembly 100 to fittings flange 55, and FIG. 11 illustrates an example of a process 1100 for installing a ball valve assembly 100 to a fittings flange 55, according to one or more aspects described herein. The operations of process 1100 presented below are intended to be illustrative and, as such, should not be viewed as limiting. In some implementations, process 1100 may be accomplished with one or more additional operations not described, and/or without one or more of the operations discussed. In some implementations, two or more of the operations of process 1100 may occur substantially simultaneously. The described operations may be accomplished using some or all of the components described in detail above with respect to ball valve assembly 100.

In an operation 1102, process 1100 may include removably coupling a threaded nipple 60 to an end of a fittings flange 55, as depicted in FIG. 10A. For example, the threaded nipple 60 may be installed and secured to the fittings flange 55, as described herein. In an operation 1104, process 1100 may include inserting a ball valve 120 engaged with dual thread retainer assembly 200 onto the threaded nipple 60 that is coupled to the end of a fittings flange, as depicted in FIG. 10B. In an operation 1106, process 1100 may include positioning anti-rotation assembly 300 (i.e., anti-rotation base 302 and the anti-rotation fork 304) and mark a stop rod position that provides a gap between the end of the anti-rotation fork 304 closer to ball valve 120 and a termination point of an interfacing region of the valve body 122, as depicted in FIG. 10C. The gap allows room for future adjustments. In some embodiments, the gap may be in a range of a distance d from about 1/16 inch to about ¼ inch relative to the end of the anti-rotation fork 304 closer to ball valve 120. In particular embodiments, the gap may be about ⅛ inch relative to the end of the anti-rotation fork 304 closer to ball valve 120. In an operation 1108, process 1100 may include securely attaching the anti-rotation base 302 to fittings flange 55, for example, as depicted in FIG. 10D, using one or more techniques described herein and/or using any other now known or future developed coupling technique. FIG. 10D depicts a perspective view of an example anti-rotation base 302 without anti-rotation fork 304 that fits and surrounds an outer edge of fittings flange 55. As depicted in FIG. 10D, in some embodiments, anti-rotation assembly 300 may be welded to an exposed surface of fittings flange 55. In an operation 1110, process 1100 may include applying one or more anti-rotation fasteners 306 (e.g., bolts) to a position at which the one or more anti-rotation fasteners 306 (e.g., bolts) may be used to attach anti-rotation fork 304 to anti-rotation base 302 as depicted, for example, in FIG. 10E, thereby completing an installation of the ball valve assembly 100 onto the fittings flange 55. For example, as depicted in FIG. 10E, anti-rotation fork 304 may then be slidably inserted over the ball valve 120 and attached to the anti-rotation base 302 (depicted, for example, in FIGS. 6A-E) via one or more anti-rotation fasteners 306.

It is to be understood that the invention is not limited in its application to the details of construction and the arrangement of the components set forth herein. The invention is capable of other embodiments and of being practiced or being carried out in various ways. Variations and modifications of the foregoing are within the scope of the present invention. It should be understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

While the preferred embodiments of the invention have been shown and described, it will be apparent to those skilled in the art that changes and modifications may be made therein without departing from the spirit of the invention, the scope of which is defined by this description.

Reference in this specification to “one implementation”, “an implementation”, “some implementations”, “various implementations”, “certain implementations”, “other implementations”, “one series of implementations”, or the like means that a particular feature, design, structure, or characteristic described in connection with the implementation is included in at least one implementation of the disclosure. The appearances of, for example, the phrase “in one implementation” or “in an implementation” in various places in the specification are not necessarily all referring to the same implementation, nor are separate or alternative implementations mutually exclusive of other implementations. Moreover, whether or not there is express reference to an “implementation” or the like, various features are described, which may be variously combined and included in some implementations, but also variously omitted in other implementations. Similarly, various features are described that may be preferences or requirements for some implementations, but not other implementations.

The language used herein has been principally selected for readability and instructional purposes, and it may not have been selected to delineate or circumscribe the inventive subject matter. Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A ball valve assembly for a railroad tank car comprising:
a ball valve removably coupled to an end of a fittings flange of a railroad tank car;
a dual thread retainer assembly affixed to an end of the ball valve opposite the fittings flange, the dual thread retainer assembly comprising:
a retainer affixed to the end of the ball valve opposite the fittings flange; and
a cap removably affixed to an end of the retainer opposite the ball valve; and
an anti-rotation assembly securely attached to the fittings flange to prevent rotation of the ball valve and the dual thread retainer assembly with respect to the fittings flange.

2. The ball valve assembly of claim 1, wherein the cap is removably affixed to the retainer via an inner threaded portion of the cap and a first outer threaded portion of the retainer.

3. The ball valve assembly of claim 2, wherein the first outer threaded portion includes one or more channels to allow leaks to be detected prior to removing the cap from the retainer.

4. The ball valve assembly of claim 2, wherein the retainer further comprises a second outer threaded portion, and wherein the retainer is affixed to the end of the ball valve opposite the fittings flange via the second outer threaded portion.

5. The ball valve assembly of claim 1, wherein the dual thread retainer assembly further comprises an O-ring at the interface between the cap and the retainer to allow the cap to be sufficiently tightened when the cap is affixed to the retainer.

6. The ball valve assembly of claim 5, wherein the O-ring is retained within the cap when the cap is removed from the retainer.

7. The ball valve assembly of claim 5, wherein the end of the retainer opposite the ball valve includes a tapered outer edge.

8. The ball valve assembly of claim 7, wherein the tapered outer edge is radiused for fitment of the O-ring.

9. The ball valve assembly of claim 7, wherein the tapered outer edge is configured to stretch the O-ring to a particular size and align the O-ring with respect to the retainer when the cap is affixed to the retainer.

10. The ball valve assembly of claim 1, wherein the anti-rotation assembly comprises a base affixed to the fittings flange and a fork secured to the base, wherein the fork is configured to prevent rotation of the ball valve and the dual thread retainer assembly with respect to the fittings flange.

11. The ball valve assembly of claim 10, wherein the base is welded to an exposed surface of the fittings flange.

12. The ball valve assembly of claim 10, wherein, when aligned, an opening in the fork and an opening in the base are each configured to receive a single fastener configured to secure the fork to the base.

13. The ball valve assembly of claim 10, wherein the opening in the fork comprises a slot configured to allow a position of the fork to be adjusted relative to the base.

14. The ball valve assembly of claim 10, wherein a portion of the fork partially surrounds and prevents rotation of the ball valve with respect to the fittings flange.

15. The ball valve assembly of claim 10, wherein the portion of the fork comprises a hexagonal grabbing profile configured to provide increased surface contact area with the ball valve.

16. A method for installing a ball valve assembly at a fittings flange of a railroad tank car, the method comprising:
removably coupling a threaded nipple to an end of a fittings flange of a railroad tank car;
coupling a ball valve to the fittings flange via the threaded nipple;
securely attaching a base of an anti-rotation assembly to the fittings flange; and
fastening a fork of the anti-rotation assembly to the base, wherein the fork is configured to prevent rotation of the ball valve with respect to the fittings flange.

17. The method of claim 16, wherein securely attaching the base of the anti-rotation assembly to the fittings flange includes marking a position that provides a gap between the fork and a termination point of an interfacing region of the ball valve.

18. The method of claim 16, the method further comprising:
affixing a dual thread retainer assembly to an end of the ball valve opposite the fittings flange, the dual thread retainer assembly comprising a retainer affixed to the end of the ball valve opposite the fittings flange and a cap removably affixed to an end of the retainer opposite the ball valve.

19. The method of claim 18, the method further comprising removably affixing a cap to the retainer via an inner threaded portion of the cap and a first outer threaded portion of the retainer, wherein the retainer further comprises a second outer threaded portion, and wherein the retainer is affixed to the end of the ball valve opposite the fittings flange via the second outer threaded portion.

20. The method of claim 19, wherein the first outer threaded portion includes one or more channels to allow leaks to be detected prior to removing the cap from the retainer.
